(19) United States
(12) Patent Application Publication
(10) Pub. No.: US 2018/0030576 A1
(43) Pub. Date: Feb. 1, 2018

(54) URANIUM HEXAFLUORIDE OFF-GAS TREATMENT SYSTEM AND METHOD

(71) Applicant: TerraPower, LLC, Bellevue, WA (US)

(72) Inventor: Inaky J. Urza, Washington, UT (US)

(73) Assignee: TerraPower, LLC, Bellevue, WA (US)

(21) Appl. No.: 15/619,338

(22) Filed: Jun. 9, 2017

Related U.S. Application Data
(60) Provisional application No. 62/368,089, filed on Jul. 28, 2016.

(51) Int. Cl. C22B 60/02; C01G 43/06

(52) U.S. Cl. CPC C22B 60/023; C01G 43/063; C01D 1/04

(57) ABSTRACT

This disclosure describes systems and methods for removing uranium hexafluoride (UF₆) and/or other uranium fluoride (uranium fluorides identified herein generally as UFₓ) gases from a hydrogen fluoride (HF) gas stream.

### CROSS REFERENCE TO RELATED APPLICATIONS

The present application claims the benefit of U.S. Provisional Patent Application No. 62/368,089, titled “URANIUM HEXAFLUORIDE OFF-GAS TREATMENT SYSTEM AND METHOD”, filed Jul. 28, 2016, which application is hereby incorporated by reference.

### INTRODUCTION

Hydrogen fluoride gas containing trace amounts of uranium hexafluoride is a byproduct of some methods of making uranium fuel for nuclear reactors.

### BRIEF DESCRIPTION OF THE DRAWINGS

The following drawing figures, which form a part of this application, are illustrative of described technology and are not meant to limit the scope of the invention as claimed in any manner, which scope shall be based on the claims appended hereto.

FIG. 1 illustrates an embodiment of a system for implementing the “cold-wall” process for the reduction of UF₆ to UF₄.

FIG. 2 illustrates an embodiment of a method for converting UF₄ to uranium metal.

FIG. 3 illustrates, at a high level, an embodiment of a simpler method for treating HF gas containing trace amounts of UFₓ such as, for example, UF₆.

FIG. 4 illustrates a general block diagram of a system for treating HF gas containing trace amounts of UFₓ such as, for example, UF₆, based on the method of FIG. 3.

FIG. 5 illustrates a more detailed system for treating HF gas containing trace amounts of UFₓ that utilizes an embodiment of the method of FIG. 3.

FIG. 6 illustrates an alternative vessel configuration for the reduction reactor, filter vessel, and backup filter vessel that may be used in the system of FIG. 1.

### DETAILED DESCRIPTION

This disclosure describes systems and methods for removing uranium hexafluoride (UF₆) and/or other uranium fluoride (uranium fluorides identified herein generally as UFₓ) gases from a hydrogen fluoride (HF) gas stream.

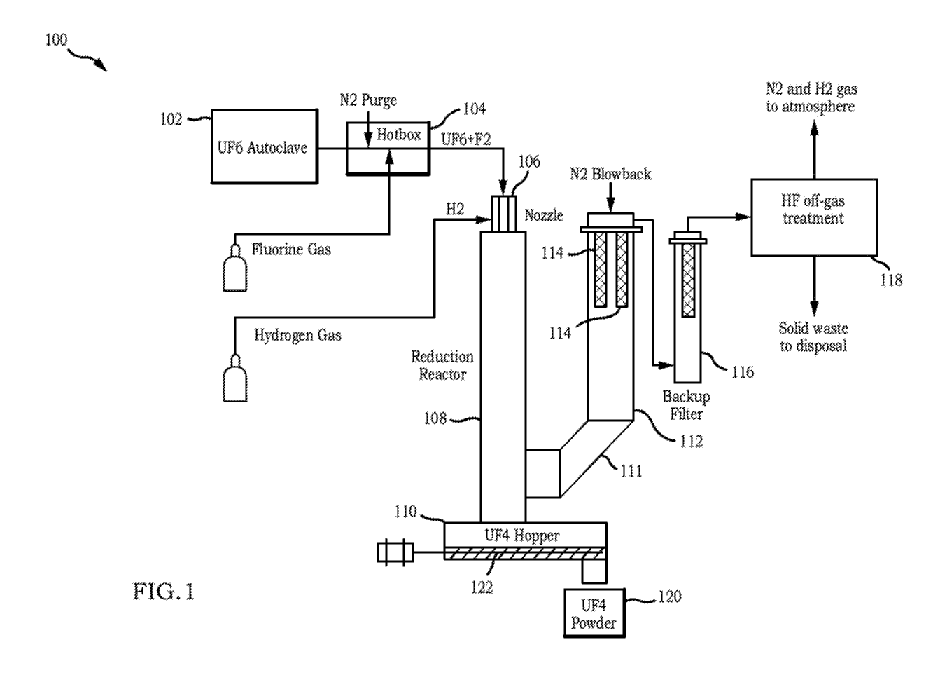

FIG. 1 illustrates an embodiment of a system for implementing the “cold-wall” process for the reduction of UF₆ to UF₄. In the system 100 as shown, UF₆, which may or may not be U-235 enriched or depleted, is provided by an autoclave 102 for blending with fluorine gas. The UF₆ is blended with fluorine gas at a high temperature, for example in a hot box 104 maintained from 95 to 110° C. and fed to a nozzle 106 at the top of a reaction vessel 108 where the gases are mixed with excess hydrogen. The hydrogen and fluorine burn to form HF which generates heat that is used to drive the UF₆ reduction to UF₄. Thus, the reaction vessel 108 may also be referred to as the reduction reactor 108. The excess hydrogen will flow through the rest of the system 100 and, ultimately, exit via the off-gas treatment system 118 without further chemical interactions.

In an embodiment, the reaction vessel 108 may be a simple tube or column of the appropriate size and volume to allow the reduction reaction to go to completion under the desired throughput rates. In an alternative embodiment, any vessel configuration that allows for gas-solid separation may be used such as cyclone separators.

In the simple gravity settling chamber column as shown, the resulting solid UF₄, in the form of a powder precipitate, drops by gravity through the reaction vessel 108 and is collected in a hopper 110 at the bottom of the vessel 108, HF off-gas exits the reaction vessel 108 via a primary off-gas filter vessel 112. In the embodiment shown, the primary off-gas filter vessel 112 may be connected to the reaction vessel using an angled pipe 111 to assist in the collection of any solid UF₄ that may be created or carried into the primary off-gas filter vessel 112.

To enhance the flow of the UF₄ solid down through the reaction vessel 108 and out of the primary off-gas filter vessel 112, various vibrating elements (not shown) may be used such as vibrating plates. The vibrating element or elements may be spaced along or at various points in the reaction vessel 108, the primary off-gas filter vessel 112, or both. For example, vibrating elements may be located at the top and bottom of the reaction vessel 108. In an alternative embodiment, the entire vessel 108 and/or the primary off-gas filter vessel 112 may be vibrated as a unit to prevent buildup on surfaces of the system 100. To account for the vibration, flexible connections (not shown) between some or all of the different components, such as the reaction vessel 108, the primary off-gas filter vessel 112, the hopper 110, etc. may be used.

In an embodiment, the HF off-gas is filtered in the primary off-gas filter vessel 112 by filters 114 at the top of the primary off-gas filter vessel 112 as shown. Any entrained solid UF₄ is thus prevented from exiting the reaction vessel/filter vessel assembly with the HF off-gas. Any UF₄ that reaches the primary filter vessel 112 is captured and returned to the reaction vessel 108 and, subsequently, to the hopper 110.

The hopper 110 directs the UF₄ powder into a UF₄ storage container 120. The hopper 110 may be of any convention design and may, or may not, include an active component (such as the screw conveyor 122 as illustrated or any other active element such as a vibrating screen) as shown to assist in the handling and transport of the UF₄ powder to the storage container 120.

In the embodiment shown, the filters 114 in the primary off-gas filter vessel 112 may be occasionally cleaned of any UF₄ particulate on the filter media by backflushing, sometimes also referred to as reverse pulse cleaning. In an embodiment, each filter 114 is independently cleaned with nitrogen on a periodic schedule, e.g., backflush for 0.5 sec after every two minutes of operation, so that at any given time only one of the filters 114 is being backflushed while the remain filters remain in normal operation. Although this embodiment uses nitrogen, any suitable gas may be used including any other inert gas.

The HF off-gas exiting the primary filter vessel 112 may further be passed through a backup filter vessel 116 as a safety measure as shown. The flow through the backup filter vessel 116 or the pressure drop across the backup filter vessel 116 may be monitored during operation for abnormal conditions (e.g., an unexpected drop in flow or increase in pressure drop across the filter 116) indicating that the filters 114 in the filter vessel 112 may have failed and particulate UF₄ is being collected in the backup filter vessel 116.

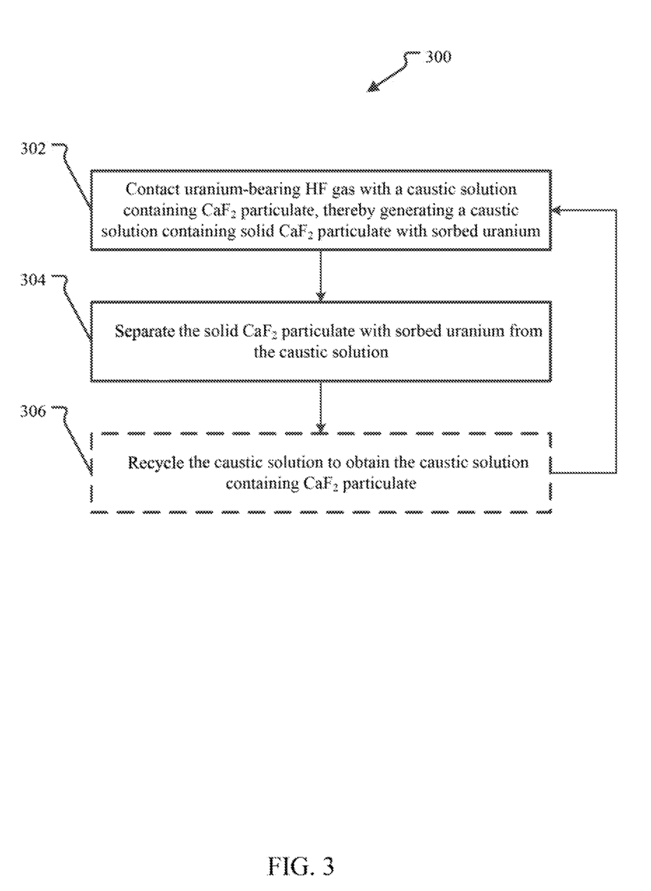

The HF off-gas that exits the primary off-gas filter vessel 112 and the backup vessel 116 is a stream of gaseous HF, excess hydrogen and nitrogen (from the filter cleaning and system purges). In addition, the HF off-gas will contain some trace amount of gaseous UF₆ and/or other gaseous uranium fluoride specie. The gaseous uranium fluorides as a group will be referred to as UFₓ to illustrate that UF₆, while the likely predominant the predominant species, is not the only uranium fluoride in the HF off-gas stream. In the embodiment shown, the gaseous HF/UFₓ off gas stream is cleaned using an off-gas treatment system 118, which is described in greater detail below with reference to FIG. 3.

Major inputs to the process (not including the off-gas treatment system 118) include UF₆ gas, fluorine, hydrogen, nitrogen purge and blow-back gases. Outputs include UF₄ powder and an HF off-gas stream containing a small amount of uranium as UF₆ and/or UFₓ.

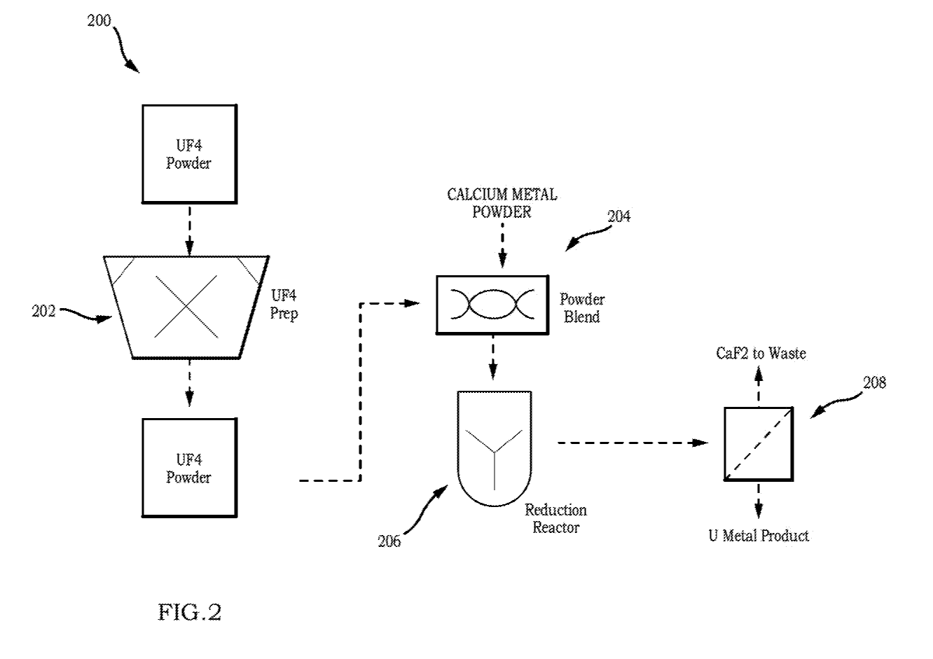

FIG. 2 illustrates an embodiment of a method for converting UF₄ to uranium metal. In the method 200 as shown, uranium metal is made by reducing the UF₄ with calcium metal. The UF₄ is first preconditioned in a preparation operation 202 that may involve a grinder or other system to generate a uniform particulate size of the UF₄. Preconditioning may also include heating or other physical manipulation of the UF₄.

Properly conditioned UF₄ is then mixed with calcium metal in a mixing operation 204. This generates a UF₄/Ca powder blend. After mixing, the UF₄/Ca powder blend is transferred to a high-temperature reactor having an inert atmosphere. Various additives may be provided also, to assist some aspect of the reaction. For example, metal Iodate (I₂) may also be mixed in to lower the CaF melt temperature to assist in separation. Alkali metal peroxide may be added as an ignition agent.

In the reactor, the mixture of UF₄ and Ca is heated to ignition (approximately 500-700° C. at 1 atm) in a reaction operation 206. Upon ignition, the exothermic reduction reaction is initiated and the additional heat generated by the reaction drives up the temperature to above the melting point of uranium (approximately 1132° C.) and, in some embodiments, even above the melting point of calcium fluoride (approximately 1418° C.). For example, reactor temperatures above 1500° C. are possible. The temperature of the reactor may be controlled by the application of active cooling such as by using a cooling jacket or other cooling elements around or in the reactor. As part of the reaction operation 206, the reactor is operated at a temperature so that molten uranium metal collects at the bottom of the reactor, upon which the much lighter (liquid or solid) CaF₂ will float as a separate phase.

The reactor may be lined with a corrosion-resistant liner such as magnesium fluoride or made from a corrosion-resistant material. Any suitable vessel design may be used for the reactor, including that of a simple hollow pressure vessel having suitable inlets and outlets for receiving the powder blend and discharging the liquid product.

In batch operation embodiments, after UF₄ and Ca have been reacted by the reaction operation 206, the collected liquid U and CaF₂ may be cooled to the solid phase and physically separated in a separation operation 208. The solid formed by such cooling is in two discrete layers, one of substantially pure U metal and the other of substantially pure CaF₂. Physical separation of the layers may be easily achieved. In an alternative embodiment of the separation operation 208, the liquid U may be removed from the reactor and collected in a storage vessel in which it is allowed to cool. The liquid CaF₂ may be separately drained from the reactor to a different storage vessel.

In an alternative embodiment, magnesium metal may be substituted for calcium metal in the UF₄ reduction process. While less expensive, the magnesium embodiment has higher uranium loss in the magnesium fluoride slag than in the calcium embodiment.

The reduction of UF₆ to UF₄ as shown in FIG. 1 and subsequent reduction of UF₄ to U metal as shown in FIG. 2, together, may be referred to as the uranium metallization process. In an embodiment, the U metallization process generates no liquid waste. For example, in an embodiment, the U metallization process waste streams are limited to HF off-gas and solid CaF₂ with trace amounts of uranium, which may be easily disposed of.

A historically difficult and important aspect of the uranium metallization process is the treatment of the gaseous HF/UFₓ off-gas stream and the design of the off-gas treatment system 118. Various methods have been used that include dry chemical traps and cold traps to recover small quantities of UF₆ and other UFₓ intermediates. For example, some systems have used sodium fluoride or anhydrous calcium sulfate traps to absorb UF₆. The traps are controlled at elevated temperatures and thermally cycled to remove the UF₆. A cold trap collection system is required to collect the UF₆. Then the off-gas is either processed through caustic scrubbers or the HF is recovered in a cold trap recovery system then vented to a caustic scrubber system. At that point, the scrubber effluent is processed in the effluent treatment system. The disadvantages of these approaches include the complexity of the process steps and the associated chemical handling/storage and disposal.

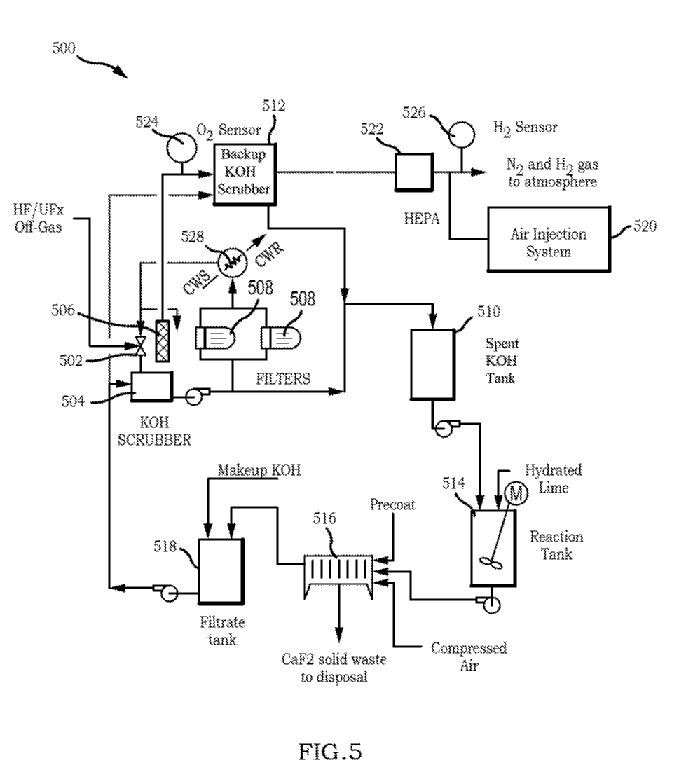

FIG. 3 illustrates, at a high level, an embodiment of a simpler method for treating HF gas containing trace amounts of UFₓ such as, for example, UF₆. The method 300 uses a caustic scrubber in which the caustic scrubber solution is provided with trace amounts of particulate CaF₂. Particulate CaF₂, for the purposes of this disclosure, refers to solid particles of CaF₂ having an identifiable particle size distribution, e.g., particles of CaF₂ that can pass through a 70 micron filter or through a No. 400 US mesh. For example, as discussed with reference to the embodiment shown in below in FIG. 5, the particulate CaF₂ has a particle size sufficiently small to pass through a 5-micron filter press.

This method 300 takes advantage of the following chemistry: a) the trace amount of UFₓ, upon contact with the scrubber solution, oxidizes to form oxidized uranium fluoride compounds (UOₓF_{y}), such as UO₂F₂; b) the oxidized uranium fluoride compounds will sorb to particulate CaF₂ in the caustic solution; and c) the HF, upon contact with the caustic scrubber solution, reacts to form soluble KF that remains in the caustic solution. Without being bound to any particular theory, it is believed the uranium compounds resulting from reaction with the caustic solution are one or more species of UOₓF_{y} that form some kind of a complex or agglomerate with individual particles of CaF₂, resulting in a larger, stable particle or agglomerate of uranium compounds and CaF₂. Furthermore, it appears that the oxidized uranium fluoride compounds interact with the surface of particles of CaF₂. Thus, as long as sufficient surface area of particulate CaF₂ and sufficient mixing are provided, the actual particle size of the particulate CaF₂ will not be important to the UOₓF_{y} removal. This can be easily achieved by providing relatively more particulate CaF₂ based on the surface area of the particles used. However, because there is only trace amounts of uranium in the caustic liquid to begin with, it is anticipated that an excess of particulate CaF₂ is very easy to achieve regardless of the particle size chosen. The term “sorb” is used herein to refer to this interaction resulting in the stable uranium compound/CaF₂ particle. Thus, the resulting uranium-bearing particles will be referred to as particulate CaF₂ with sorbed U compounds.

At a high level, the method 300 can be described as contacting operation 302 followed by a separation operation 304. In the contacting operation 302, the uranium-bearing HF off-gas stream is brought into contact with a caustic solution, such as potassium hydroxide (KOH) solution, containing particulate CaF₂. As described above, the HF off-gas stream includes HF, excess hydrogen and nitrogen, and some trace amount of gaseous UFₓ. Because of the reactions described above, this contacting consumes the HF and results in a liquid-gas mixture that includes a uranium-bearing caustic solution and non-condensable components including H₂ and N₂. Depending on how the efficient the contacting is between the two reactants, the reaction may be almost instantaneous.

The particulate CaF₂ may be provided in any manner and may have any particle size. For example, in an embodiment an amount of particulate CaF₂ may be mixed into a batch of caustic solution to create a caustic/CaF₂ mixture for use in the method 300. In a particularly elegant embodiment, discussed in greater detail below, the particulate CaF₂ may be a byproduct of a caustic recycling operation, such as recycling operation 306.

The resulting liquid-gas mixture will readily separate into a uranium-bearing liquid stream and a hydrogen/nitrogen gas stream. Thus, in one embodiment, the separating operation 304 involves simply collecting the liquid-gas mixture from the contacting operation 302 and holding it for a time sufficient to allow the reaction to occur and the phases to separate.

The efficiency of the contacting operation 302 may be improved by actively mixing the off-gas stream and the caustic solution. In an embodiment, discussed in greater detail below, this may be achieved by using a venturi to ensure adequate mixing of the off-gas stream with the caustic solution. In this embodiment, the off-gas stream is delivered to the suction inlet of the venturi and is drawn into the venturi through the suction created by the flow of the caustic through the motive inlet of the venturi. The two streams become well mixed as they pass through the throat of the venturi and exit as a liquid-gas mixture at the venturi's discharge. The flows can be controlled so that the reactions are driven substantially to completion within the venturi such that the discharge from the venturi consists of a liquid-gas mixture of a uranium-bearing liquid stream and non-condensable hydrogen and nitrogen gas.

Other methods and systems of mixing or combining a gas stream with a liquid stream to encourage a chemical reaction are also possible. Many such systems are known and any suitable technology may be used. For example, in an alternative embodiment, a packed column, a bubble column, a spray tower, a plate column, a falling-film column, a diffusion tank, or a rotating disc diffuser, to name but a few, may be contemplated.

The separating operation 304 may also include separating the uranium-bearing CaF₂ particulate from the caustic solution. In practice, it has been determined that the uranium-bearing CaF₂ particulates are easily filtered from the caustic solution when passed through a 50- to 70-micron filter when the original particulate CaF₂ in the solution have a particle size of less than 10 microns. It is believed a CaF₂ particle size greater than 10 microns could also be effective.

The method 300 may also include an optional caustic recycle 306. This operation recycles the caustic solution so that it may be reused in the contacting operation 302. In a KOH caustic embodiment, for example, the KF created by the reaction with the HF in the off-gas may be recycled back into KOH by using Ca(OH)₂.

In an embodiment, particulate CaF₂ may be added as byproduct of the optional caustic recycle operation 306. In an embodiment of a recycle operation, the filtered caustic solution will have some amount of the cation of the caustic in the form of a fluoride, e.g., KF if the caustic solution is a KOH solution. The fluoride may be removed by adding Ca(OH)₂ to the filtered caustic solution, so that the fluoride forms a particulate CaF₂ precipitate and new KOH. Again, using the example of KOH, the reaction is as follows:

Ca(OH)₂+2KF→2KOH+CaF_{2 (solid particulate)}

So much CaF₂ may be created in the recycling operation 306 that most CaF₂ may need to be removed before the recycled caustic solution can be reused. However, the recycling operation 306 may include allowing some of the particulate CaF₂ to remain in the recycled caustic solution. Thus, the recycled caustic solution can be reused in the contacting operation 302 (as illustrated) as is without the need to introduce additional fresh particulate CaF₂.

In a batch embodiment of the method 300 using KOH solution as the caustic solution, an amount of initial KOH solution with a pH 14 is provided. The contacting operation 302 and separation operation 304 are performed with the KOH solution until the pH drops below a threshold, for example 12, or for some predetermined period of time, after which some or all of the KOH solution is replaced with fresh or recycled KOH solution. Continuous embodiments are also possible in which a portion of the KOH solution is being continuously recycled by the recycle operation 306 so that the pH and KOH concentration of the caustic solution are maintained at some steady state value.

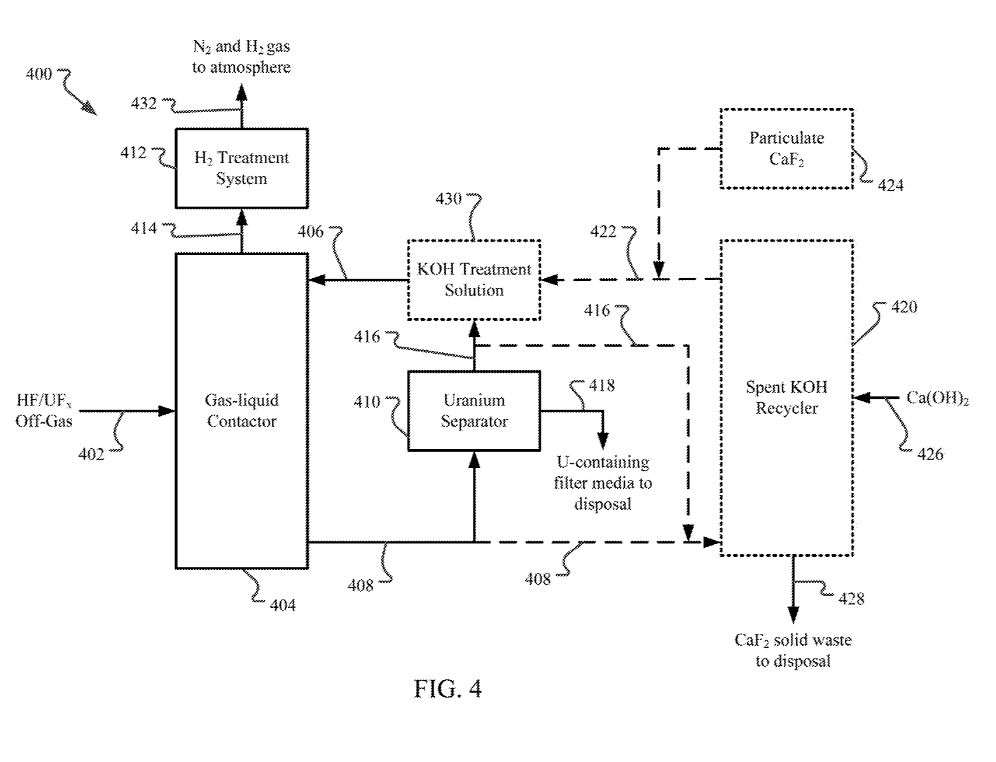

FIG. 4 illustrates a general block diagram of a system for treating HF gas containing trace amounts of UFₓ such as, for example, UF₆, based on an embodiment of the method of FIG. 3. The system 400, as illustrated, continuously receives the incoming HF off-gas stream 402 and treats it in a gas-liquid contactor 404. As discussed above, the gas-liquid contactor 404 may be of any suitable type and may include one or more contacting stages, vessels, venturis, valves, nozzles, flowmeters, temperature sensors, pressure sensors, and other individual components. For example, in an embodiment the contactor 404 includes a gas inlet which may include a nozzle that directs the received gas into a reaction vessel containing a caustic solution where the mixing occurs. In an alternative embodiment discussed in greater detail below, the gas-liquid contactor 404 may include a venturi that receives the inlet gas and caustic solution and discharges the combined product into a holding vessel. In yet another embodiment, the contactor may consist of a venturi followed by a liquid-gas separator.

In the gas-liquid contactor 404, the received HF/UFₓ gas 402 is mixed with a fresh caustic treatment solution 406, a fresh KOH treatment solution is illustrated in FIG. 4, that contains the particulate CaF₂. In an embodiment, the fresh KOH treatment solution 406 may be obtained from an optional reservoir 430, such as a holding tank, or directly from the uranium separator 410 and/or the spent KOH treatment solution recycler 420 as discussed below. The received gas 402 may be mixed with the fresh KOH treatment solution 406 so that some, substantially all, or all incoming HF is consumed and converted to KF and H₂O. In addition, the UFₓ gas is partially or completely contacted with the fresh KOH treatment solution 406 as a result of the mixing, thereby causing the UFₓ to react with the KOH treatment solution to form the oxidized uranium fluoride compounds.

The non-condensable H₂ gas from the HF off-gas is allowed to separate from the contacted solution and is vented from the contactor 404 for subsequent treatment and eventual release to the atmosphere by an H₂ gas treatment system 412. Alternatively, the H₂ gas may be flared or otherwise collected and burned instead of being released to the atmosphere. Note that the received HF/UFₓ off-gas 402 may include N₂ gas. Any such N₂ gas will be chemically unaffected by the system 400 and will be discharged along with the H₂ gas 414 through gas treatment system 412.

After separation of the H₂ (and any N₂) gas, the liquid effluent of the contactor 404 is a uranium-bearing KOH solution 408, which is then transferred to a uranium separator 410. In this embodiment, the uranium-bearing KOH solution 408 will be a solution of KF, KOH and particulate CaF₂, in which at least some of the CaF₂ will have combined with U compounds generated by the reaction of UFₓ with the water in the solution.

In an alternative embodiment, the gas-liquid contactor 404 may be operated so that only partial conversion of HF is achieved. In this embodiment, the contactor 404 may be operated so that all or substantially all of the UFₓ gas is contacted by or solubilized into the fresh KOH treatment solution 406 but that excess HF gas remains. This may be suitable when the goal is to remove all uranium but retain some HF for sale or later use. However, for the purposes of the remaining discussion, it will be assumed that the contactor 404 is operated to achieve complete, or near complete, conversion of both the HF and UFₓ received by the contactor 404.

The contactor 404 may be operated in a batch, semi-batch, or continuous fashion. When in continuous operation, the HF/UFₓ gas 402 and the fresh KOH treatment solution 406 are received as separate streams that are combined by the contactor 404. The contactor 404 further operates to continuously separate the effluent streams, i.e., the non-condensable H₂ gas stream 414 and uranium-bearing KOH solution 408 stream. The non-condensable gas stream 414 is discharged to the gas treatment system 412 to be vented to atmosphere. In an embodiment, the gas stream 414 is diluted by the gas treatment system 412 to reduce the concentration of H₂ to acceptable levels. The uranium-bearing KOH solution 408 stream is passed to the uranium separator 410 for uranium removal.

The uranium separator 410 removes the particles of CaF₂ along with any sorbed uranium compounds from the uranium-bearing KOH solution 408. This may be done by filtration or by any other suitable liquid-solid separation technique. When done by filtration, the uranium compounds will collect on the filter media until the media is replaced. The uranium-bearing filter media may then be disposed as a solid waste product 418 of the separator 410. When the separation is achieved using other techniques, the uranium-bearing solid waste 418 may be in some other form, such as a precipitate, agglomerate, or complex. Depending on the embodiment, particles of CaF₂ that have not combined with U, referred to as “free CaF₂” to distinguish it from particles of CaF₂ with sorbed U, may or may not be removed by the uranium separator 410. In the embodiment shown, the uranium separator captures particles of CaF₂ with sorbed U but passes free CaF₂. This may be achieved, for example, by using a filter sized to remove particles of CaF₂ with sorbed U but to pass the free CaF₂ particles. In this embodiment, the effluent of the uranium separator 410 is a filtered KOH treatment solution 416 that contains free CaF₂ suitable for sorbing with uranium compounds in the next pass through the contactor.

In an alternative embodiment, the uranium separator 410 may remove all the particulate CaF₂ regardless of whether it is sorbed to uranium or not. In this embodiment, additional CaF₂ particulate may be added to the filtered KOH treatment solution 416 from an optional particulate CaF₂ source 424.

In the embodiment shown, the filtered KOH treatment solution 416 and particulate CaF₂ is transferred back to the gas-liquid contactor 404, either directly or via the optional reservoir 430, and reused as fresh KOH treatment solution 406 in contacting additional HF/UFₓ gas 402. Thus, the contactor 404 and separator 410 may be operated as a closed loop system that receives HF/UFₓ gas 402 and discharges H₂ gas 414 and a uranium-bearing solid waste product 418 stream.

The separator 410 may be operated as a batch, semi-batch, or continuous stage of treatment. For example, in an embodiment the contactor 404 and the separator 410 are operated continuously as a closed loop treatment of the HF/UFₓ gas 402 until such time as the KOH treatment solution is considered spent. In an alternative, batch embodiment, the contactor 404 is operated continuously until a sufficient amount of uranium-bearing KOH treatment solution 408 has been generated, at which time the uranium-bearing KOH solution 408 is transferred to the separator 410 for treatment in a batch operation.

In a continuous embodiment, reuse of filtered KOH treatment solution 416 as KOH treatment solution 408 may be performed until the filtered KOH treatment solution 416 exiting the separator 410 is spent and no longer has sufficient KOH in solution to convert the incoming HF gas 402. However, complete consumption of the KOH treatment solution is not necessarily efficient or preferable in some situations and the KOH treatment solution may be recycled or replaced based on a mass balance taking into account the amount of HF removed, based on the volume of HF gas 402 treated, based on a monitored pH of the treatment solution 408, or based on the time since the last replacement.

In the embodiment illustrated in FIG. 4, an optional KOH treatment solution recycler 420 is provided to recycle spent KOH treatment solution by converting the KF back into KOH. The recycler 420 may receive spent KOH treatment solution either from the gas-liquid contactor 404 or from the uranium separator 410. In an embodiment the recycler 420 converts KF back into KOH utilizing the reaction previously cited above by adding Ca(OH)₂ 426 to the spent solution. This reaction also generates solid particulate, free CaF₂. This newly generated particulate CaF₂ may be removed in whole or in part from the recycled KOH treatment solution. In an embodiment, the recycler 420 is operated so that enough free CaF₂ generated by the addition of Ca(OH)₂ is retained in a particulate form to replace the amount of CaF₂ removed by the uranium separator 410 as part of the uranium removal.

In this embodiment, the output of the recycler 420 is a recycled KOH treatment solution 422 having some particulate free CaF₂ ready for use as the input of fresh KOH treatment solution 406 for the gas-liquid contactor 404. In the embodiment shown, the recycled KOH treatment solution 422 is transferred back to the gas-liquid contactor 404, either directly or via the optional reservoir 430, and reused as fresh KOH treatment solution 406 in contacting additional HF/UFₓ gas 402.

As with the separator 410 and contactor 404, the recycling may be done as a batch, semi-batch or continuous operation. For example, in the embodiment shown the recycler 420 is operated as a batch operation, illustrated by the inflows and outflows being shown as a dashed line. In this embodiment, upon determination that the KOH treatment solution needs to be recycled, which may be determined by monitoring the pH or the amount of CaF₂ of the treatment solution 406, some amount of KOH treatment solution from the system may be transferred to the spent KOH recycler 420 for treatment. For example, if the monitored pH of the KOH treatment solution at any spot in the system falls below a selected lower threshold, the batch recycling operation may be performed. Suitable pH thresholds may be 11, 12, 12.5, 13 or 13.5. In an alternative embodiment, the spent KOH recycler 420 may be continuously operating on a side stream of treatment solution to maintain the pH or CaF₂ content of the fresh KOH treatment solution 406 at a selected constant level, such as at a pH level from 11 to 14. In a simpler embodiment, the recycling may be done periodically on a schedule based on the amount of HF gas treated or based on a monitored KOH concentration in the solution 408.

The major inputs to the HF gas treatment system 400 are the HF/UFₓ gas 402, hydrated lime 426 and, possibly, a small amount of makeup potassium hydroxide, particulate CaF₂, and deionized water. The output streams are a relatively large stream of calcium fluoride solid 428, a much smaller stream 418 of uranium-bearing calcium fluoride captured on filter media, and scrubbed process off-gases 432. The system 400 is effective in isolating the uranium into a relatively small, solid waste stream 418 that is easily handled and efficiently disposed of.

FIG. 5 illustrates a more detailed system for treating HF gas containing trace amounts of UFₓ that utilizes an embodiment of the method of FIG. 3. In the system 500 as shown, the mixed HF/UFₓ gas is received, such as from the UF₆ to UF₄ reduction process described above with reference to FIG. 1, and then mixed with a KOH treatment solution in a venturi to generate a venturi discharge stream. In the embodiment shown, the KOH treatment solution is passed through the motive inlet of the venturi 502 and the inlet gas connected to the suction inlet so that pumping the treatment solution through the venturi draws in the inlet gas at a rate that is a known function of the treatment solution flowrate.

The venturi discharges into a vessel identified as the KOH scrubber 504 in FIG. 5. In the embodiment shown, the scrubber 504 is a closed holding tank having an inlet for the venturi discharge, a gas outlet to a packed column 506 and a liquid outlet, or drain, for the uranium-bearing KOH treatment solution. The KOH scrubber 504 provides additional holding time to the discharge stream from the venturi, which allows for additional contact time for the reaction to occur and for the non-condensable H₂ and N₂ gases to separate from the treatment solution. In an embodiment, the holding tank is only partially full of KOH treatment solution, the rest of the tank being a headspace. The venturi discharge may be directed into the scrubber 504 through the top as shown or may be into the side or the bottom of the tank, depending on the amount of secondary mixing and agitation desired.

The packed column 506 is provided as a secondary treatment of the H₂ (and any N₂) gas to prevent any unreacted HF or UFₓ gas from exiting the gas outlet of the scrubber 504. In the embodiment shown, the packed column 506 includes a flow, under gravity, of KOH treatment solution which discharges into the scrubber 504 through the scrubber's gas outlet.

During normal treatment, uranium-bearing KOH treatment solution is pumped from the scrubber through one or the other of the filters 508. In the embodiment shown, two filters 508 are provided so that one filter may be easily removed and replaced with a new filter without interrupting the continuous treatment of the KOH treatment solution. Filters may be deemed spent and replaced based on activity, time in service, throughput, differential pressure drop indicative of clogging of the filter, or any other suitable method. For example, a differential pressure drop threshold across the filter at a designated flowrate may be used to determine when to replace a filter. Activity is also easily monitored and a filter 508 may be replaced upon determination that the measured activity is at or above some predetermined threshold. The filtrate effluent of the filters 508 is a filtered KOH treatment solution which is returned to motive inlet of the venturi 502.

A condenser 528 may be provided as shown to maintain the temperature of the caustic solution in the scrubber circuit. Optionally and additionally, another condenser (not shown) may be provided in the gas outlet line after the packed column 506 to capture any volatilized caustic solution from the gas effluent and to return the captured solution to the KOH scrubber 504.

FIG. 5 also shows that the KOH treatment solution discharged from the scrubber 504 may be alternatively pumped to a spent KOH solution holding tank 510. This holding tank 510 is provided to allow the recycling system of the system 500 to operate in a batch mode. That is, an amount of treatment solution may be transferred to the holding tank 510 at any time (with fresh, makeup treatment solution being supplied from the filtrate tank 518 to keep the amount of treatment solution in the scrubber 504 at a desired level). An additional filter (not shown) may be included before the spent KOH solution holding tank 510 in order to prevent any uranium in the spent KOH solution from entering the recycle loop. Such a filter may be sized much smaller than the scrubber filters 508 to reduce the chance that any uranium-bearing solids may pass into the spent KOH tank 510.

The spent KOH solution holding tank 510 feeds a reaction tank 514 in which hydrated lime is mixed with the spent KOH solution. Hydrated lime may be used or, as discussed above, any form of calcium oxide, hydroxide or equivalent base may be used. In an embodiment, the reaction tank 514 is operated as a batch reactor in which all the removed spent KOH solution is transferred into the reaction tank 514 and treated at one time. As discussed above, the KF in the spent KOH solution is converted into CAF₂ and KOH by the reaction. In an embodiment, the concentration of KF of the contents of the reaction tank 514 is determined, either through direct measurement or estimated based on the volume of gas treated, and then additional hydrated lime is added in an amount sufficient to completely convert the KF to KOH. In an alternative embodiment, other methods may be used to determine when the spent KOH solution has been sufficiently regenerated, for example by calculation, by monitoring other parameters such as KOH concentration, KF concentration, etc.

The contents of the reaction tank 514, after the reaction is deemed sufficiently complete as indicated based on the pH or some other parameter, are transferred through a filtration system, illustrated as filter press 516. The filter press 516 may be of any suitable type including manual or automatic plate and frame presses and/or recessed plate presses. Alternatively, any other filtration or liquid-solid separation system may be used.

One aspect of the filter press 516 is that it can be operated so that some amount of small particulate CaF₂ can be allowed to pass through the press. This provides a ready source of fresh CaF₂, and the fresh, particulate CaF₂ is already in the recycled KOH treatment solution that exits the filter press 516. In an embodiment, a filter press 516 nominally sized to remove particulate larger 5 microns has been found to pass sufficient particulate CaF₂ to be used without needing any further addition of particulate CaF₂ to the KOH solution. A precoat may be used to assist consistent filtration in the filter press and compressed air may be used depending on the design of the filter press. The CaF₂ that does not exit with the KOH solution will be collected as a filter cake and disposed of as a solid waste.

In the embodiment shown, the effluent of the filter press 516 is passed to a filtrate holding tank 518 where it can be held until the next batch recycle operation. At that time, the recycled KOH solution with particulate CaF₂ in the filtrate holding tank 518 may be pumped to the scrubber 504, as shown, to make up for the volume of spent KOH removed, as discussed above. Makeup KOH and deionized water may also be added to the filtrate holding tank 518 as necessary to keep the KOH treatment solution at the desired pH and KOH concentration.

The system 500 is also illustrated with a backup scrubber 512 for safety. The backup scrubber 512 is optional and may be any type of gas-liquid contactor that contacts KOH treatment solution with the gas discharged from the packed column 506.

An air injection system 520 is further illustrated that supplies air to the gas discharged from the scrubber 504 for the purpose of diluting the H₂ gas sufficiently to make it safe to vent to the atmosphere, such as to less than the Lower Explosive Limit (LEL) for H₂ in air. An H2 monitor 526 may be provided to ensure this treatment is being achieved and to control the amount of air being added. A HEPA (high efficiency particulate air) filter 522 is also provided for cleaning of the gas discharge.

The scrubber circuit including the scrubber 504 and filters 514 is a closed, airtight system to prevent exposure of the solution and gas streams to the atmosphere. In the embodiment shown, an oxygen sensor 524 is provided in the gas output to detect the presence of oxygen in the gas stream. The presence of oxygen is indicative of a leak in the process equipment and is potentially a safety concern.

The major inputs to the off-gas treatment system 500 are hydrated lime and a small amount of makeup potassium hydroxide and deionized water. Outputs are calcium fluoride filter cake, calcium fluoride with some uranium contamination captured on filter media, and scrubbed process off-gases.

A different embodiment of the above systems and methods does not use a KOH solution with particulate CaF₂ but, rather, uses a CaF₂ contacting vessel to remove the uranium. In this embodiment, the KOH solution that does not have any CaF₂ is used to contact the inlet HF/UFₓ gas to obtain a uranium-bearing KOH solution. The uranium-bearing KOH solution is then passed through a CaF₂ contactor. The CaF₂ contactor may be a simple vessel containing a packed bed of particles of CaF₂. In an alternative embodiment, the CaF₂ contactor may be one or more filters in which the filter media contains particulate CaF₂ or some type of media with exposed surface area of CaF₂.

Schematically, such embodiments would appear similar to those systems provided in FIGS. 4 and 5. In FIG. 4, the uranium separator 410 would include the CaF₂ contactor, the other main difference in systems being that the various KOH solutions no longer require particulate CaF₂. Likewise, in FIG. 5, the filters 508 would be replaced by the CaF₂ contactor (which, as discussed above, may be a filter with CaF₂ on the filter media) and, again, the main difference in systems being that the various KOH solutions no longer require particulate CaF₂.

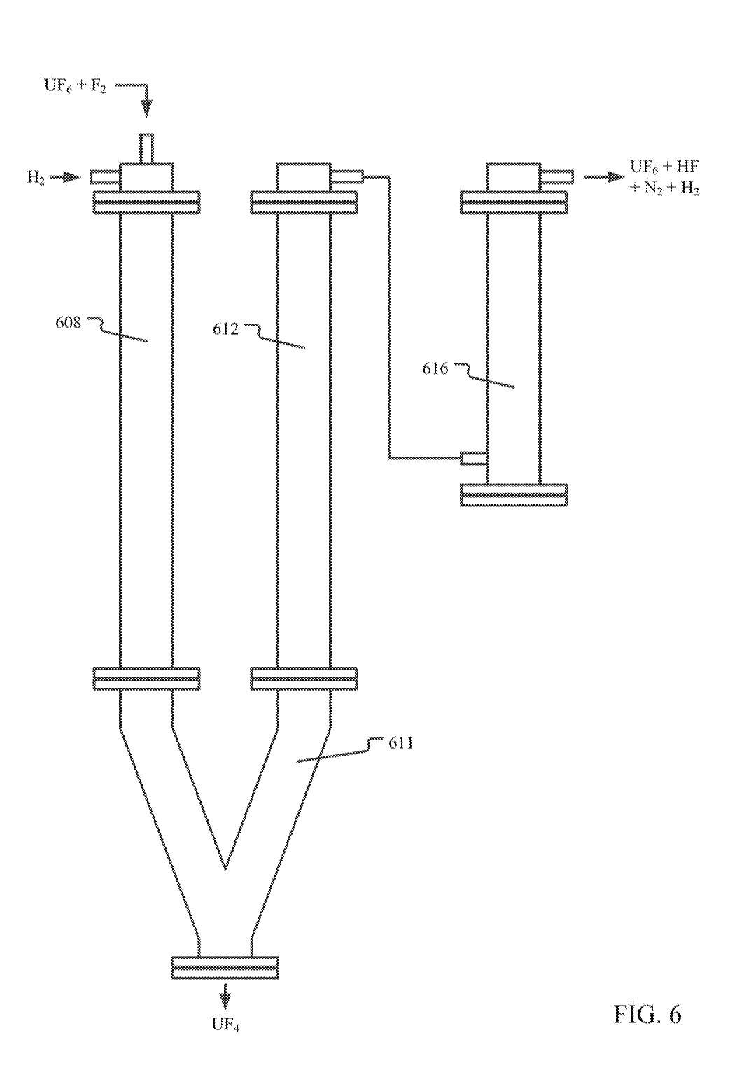

FIG. 6 illustrates an alternative vessel configuration for the reduction reactor, filter vessel, and backup filter vessel that may be used in the system of FIG. 1. In the embodiment shown, the reduction reactor 608 and the filter vessel 612 are parallel columns of the same length and diameter attached at the bottom to a symmetrical Y-shaped connector 611. These take the place of the reduction reactor 108, primary off-gas filter vessel 112 and angled pipe 111 in FIG. 1. The reduction reactor 608, the filter vessel 612, and Y connector 611 assembly may be supported by a support structure attached to the Y connector 611 or by the attachment to the hopper (not shown). In the illustration, the high angle of the Y connector improves the collection of the solid UF₄ by eliminating horizontal and near horizontal surfaces where the powder can easily collect. A vibrator may be easily attached to the assembly to further improve the solid collection. One or more filters (not shown) may be included in the filter vessel 612 and, additionally, in the backup filter vessel 616. In an alternative embodiment, the reduction reactor 608 and the filter vessel 612 may or may not be parallel columns and may or may not be the same length or the same diameter.

Notwithstanding the appended claims, the disclosure is also defined by the following clauses:

1. A method for treating hydrogen fluoride gas containing trace amounts of uranium fluoride gas comprising:

contacting the hydrogen fluoride gas containing trace amounts of uranium fluoride gas with a caustic solution containing particulate CaF₂; and

separating the particulate CaF₂ from the caustic solution after the contacting operation.

2. The method of clause 1 wherein the solution is an aqueous solution having a pH of greater than 11.

3. The method of clause 1 or 2 wherein the solution is an aqueous KOH solution having a pH of 12 or more.

4. The method of any of clauses 1-3 wherein the separating comprises:

passing, after the contacting operation, the solution containing particulate CaF₂ through a filter sized to remove at least some of the particulate CaF₂.

5. The method of any of clauses 1-4 wherein hydrogen fluoride gas further includes hydrogen gas wherein the contacting comprises:

combining the hydrogen fluoride gas containing trace amounts of uranium fluoride gas and the solution containing particulate CaF₂ using a venturi to generate a combined gas/solution/particulate stream;

collecting the combined gas/solution/particulate stream in a vessel; and

allowing the combined gas/solution/particulate stream to separate into a hydrogen gas stream and a uranium-bearing caustic solution containing particulate CaF₂.

6. A method for collecting uranium from a HF gas containing trace amounts of UF₆ comprising:

mixing a raw gas stream of the HF gas containing a first concentration of UF₆ with a KOH treatment solution, the KOH treatment solution being an aqueous solution of KOH having a pH of greater than 11 and including an amount of particulate CaF₂, thereby generating a uranium-bearing combined stream containing KOH and KF in solution and particulate CaF₂ with sorbed U compounds.

7. The method of clause 6 further comprising:

separating the particulate CaF₂ with sorbed U compounds from the uranium-bearing liquid stream, thereby generating a filtered KOH solution stream;

wherein the separating includes passing the uranium-bearing liquid stream through a filter sized to remove at least some of the particulate CaF₂ with sorbed U compounds.

8. A system for removing uranium from a hydrogen fluoride gas containing at least some uranium hexafluoride, the system comprising:

a gas-liquid contactor that
a) receives the hydrogen fluoride gas containing uranium hexafluoride at a gas inlet,
b) receives a KOH treatment solution containing particulate CaF₂ at a solution inlet, and
c) discharges a uranium-bearing KOH solution including KOH, KF, and particulate CaF₂ with sorbed U compounds from a solution outlet;

a first separator that receives the uranium-bearing KOH solution from the solution outlet, the first separator adapted to separate particulate CaF₂ from the uranium-bearing KOH solution to obtain a filtered KOH treatment solution containing KF and KOH and a solid residue of particulate CaF₂ and sorbed U compounds; and

a KOH treatment solution recycler that receives either uranium-bearing KOH solution or filtered KOH treatment solution and adds Ca(OH)₂ to the received solution to convert the KF into KOH and particulate CaF₂, thereby generating the KOH treatment solution containing particulate CaF₂.

9. The system of clause 8 wherein the gas-liquid contactor comprises:

a venturi that has the KOH treatment solution inlet and the hydrogen fluoride gas inlet and a discharge that discharges a mixed venturi output stream created by the mixing of the hydrogen fluoride gas, uranium hexafluoride, KOH solution and particulate CaF₂ within the venturi; and

a KOH holding vessel having a mixture inlet and the uranium-bearing KOH solution outlet, wherein the KOH contacting vessel receives the discharged mixed venturi output stream.

10. The system of clauses 8 and 9 wherein the first separator comprises:

at least one filter, the filter having a filter media sized to retain the particulate CaF₂ with sorbed U compounds on the filter media.

11. The system of clause 10 wherein the at least one filter has a filter media sized to pass particulate CaF₂ but to retain particulate CaF₂ with sorbed U compounds.

12. The system of any of clauses 8-11 wherein the KOH treatment solution recycler comprises:

a Ca(OH)₂ mixing vessel that mixes Ca(OH)₂ with the received solution containing KF and KOH to convert the KF into KOH and particulate CaF₂, thereby generating a recycled KOH treatment solution stream containing particulate CaF₂,

a second separator that separates at least some particulate CaF₂ from the recycled KOH treatment solution stream; and

a makeup vessel that receives a fresh KOH solution and the recycled KOH treatment solution to generate the KOH treatment solution containing particulate CaF₂.

13. The system of any of clauses 8-12 wherein the hydrogen fluoride gas containing at least some uranium hexafluoride further includes at least some hydrogen gas and the system further comprises:

the KOH holding vessel having a treated gas outlet in addition to the mixture inlet and the uranium-bearing KOH solution outlet, wherein the KOH contacting vessel receives the discharged mixed venturi output stream which then separates into a vessel gas and the uranium-bearing KOH solution, the vessel gas being discharged from the KOH contacting vessel via the treated gas outlet and the uranium-bearing KOH solution being discharged from the uranium-bearing KOH solution outlet; and

a packed column having a vessel gas inlet, a filtered KOH treatment solution inlet and a treated hydrogen gas outlet, wherein the packed column contacts the vessel gas with filtered KOH treatment solution prior to discharging the treated hydrogen gas.

The system of claim 13 wherein the at least one filter has a filter media sized to pass particulate CaF₂ but to retain particulate CaF₂ with sorbed U compounds.

15. The system of claim 11 wherein the KOH treatment solution recycler comprises:

a Ca(OH)₂ mixing vessel that mixes Ca(OH)₂ with the received solution containing KF and KOH to convert the KF into KOH and particulate CaF₂, thereby generating a recycled KOH treatment solution stream containing particulate CaF₂,

a second separator that separates at least some particulate CaF₂ from the recycled KOH treatment solution stream; and

a makeup vessel that receives a fresh KOH solution and the recycled KOH treatment solution to generate the KOH treatment solution containing particulate CaF₂.

16. The system of claim 12 wherein the hydrogen fluoride gas containing at least some uranium hexafluoride further includes at least some hydrogen gas and the system further comprises:

the KOH holding vessel having a treated gas outlet in addition to the mixture inlet and the uranium-bearing KOH solution outlet, wherein the KOH contacting vessel receives the discharged mixed venturi output stream which then separates into a vessel gas and the uranium-bearing KOH solution, the vessel gas being discharged from the KOH contacting vessel via the treated gas outlet and the uranium-bearing KOH solution being discharged from the uranium-bearing KOH solution outlet; and

a packed column having a vessel gas inlet, a filtered KOH treatment solution inlet and a treated hydrogen gas outlet, wherein the packed column contacts the vessel gas with filtered KOH treatment solution prior to discharging the treated hydrogen gas.

It will be clear that the systems and methods described herein are well adapted to attain the ends and advantages mentioned as well as those inherent therein. Those skilled in the art will recognize that the methods and systems within this specification may be implemented in many manners and as such is not to be limited by the foregoing exemplified embodiments and examples. In this regard, any number of the features of the different embodiments described herein may be combined into one single embodiment and alternate embodiments having fewer than or more than all of the features herein described are possible.

While various embodiments have been described for purposes of this disclosure, various changes and modifications may be made which are well within the scope contemplated by the present disclosure. For example, in the embodiment described with reference to FIG. 4, free CaF₂ need not be provided by the recycler 420. Instead, the recycler may remove all CaF₂ generated from the recycling reactor and free CaF₂ may be added as a separate operation so that the exact amount and size of the CaF₂ in the system can be controlled. Numerous other changes may be made which will readily suggest themselves to those skilled in the art and which are encompassed in the spirit of the disclosure.

What is claimed is:

1. A method for treating hydrogen fluoride gas containing trace amounts of uranium fluoride gas comprising:
contacting the hydrogen fluoride gas containing trace amounts of uranium fluoride gas with a caustic solution containing particulate CaF₂; and
separating the particulate CaF₂ from the caustic solution after the contacting operation.

2. The method of claim 1 wherein the solution is an aqueous solution having a pH of greater than 11.

3. The method of claim 1 wherein the solution is an aqueous KOH solution having a pH of 12 or more.

4. The method of claim 1 wherein the separating comprises:
passing, after the contacting operation, the solution containing particulate CaF₂ through a filter sized to remove at least some of the particulate CaF₂.

5. The method of claim 1 wherein hydrogen fluoride gas further includes hydrogen gas and wherein the contacting further comprises:
combining the hydrogen fluoride gas containing trace amounts of uranium fluoride gas and the solution containing particulate CaF₂ using a venturi to generate a combined gas/solution/particulate stream.

6. The method of claim 5 further comprising:
collecting the combined gas/solution/particulate stream in a vessel; and

7. The method of claim 6 further comprising:
allowing the combined gas/solution/particulate stream to separate into a hydrogen gas stream and a uranium-bearing caustic solution containing particulate CaF₂.

8. A method for collecting uranium from a HF gas containing trace amounts of UF₆ comprising:
mixing a raw gas stream of the HF gas containing a first concentration of UF₆ with a KOH treatment solution, the KOH treatment solution being an aqueous solution of KOH having a pH of greater than 11 and including an amount of particulate CaF₂, thereby generating a uranium-bearing combined stream containing KOH and KF in solution and particulate CaF₂ with sorbed U compounds.

9. The method of claim 8 further comprising:
separating the particulate CaF₂ with sorbed U compounds from the uranium-bearing liquid stream, thereby generating a filtered KOH solution stream;

10. The method of claim 9 wherein the separating includes passing the uranium-bearing liquid stream through a filter sized to remove at least some of the particulate CaF₂ with sorbed U compounds.

11. A system for removing uranium from a hydrogen fluoride gas containing at least some uranium hexafluoride, the system comprising:
a gas-liquid contactor that
a) receives the hydrogen fluoride gas containing uranium hexafluoride at a gas inlet,
b) receives a KOH treatment solution containing particulate CaF₂ at a solution inlet, and
c) discharges a uranium-bearing KOH solution including KOH, KF, and particulate CaF₂ with sorbed U compounds from a solution outlet;
a first separator that receives the uranium-bearing KOH solution from the solution outlet, the first separator adapted to separate particulate CaF₂ from the uranium-bearing KOH solution to obtain a filtered KOH treatment solution containing KF and KOH and a solid residue of particulate CaF₂ and sorbed U compounds; and
a KOH treatment solution recycler that receives either uranium-bearing KOH solution or filtered KOH treatment solution and adds Ca(OH)₂ to the received solution to convert the KF into KOH and particulate CaF₂, thereby generating the KOH treatment solution containing particulate CaF₂.

12. The system of claim 11 wherein the gas-liquid contactor comprises:
a venturi that has the KOH treatment solution inlet and the hydrogen fluoride gas inlet and a discharge that discharges a mixed venturi output stream created by the mixing of the hydrogen fluoride gas, uranium hexafluoride, KOH solution and particulate CaF₂ within the venturi; and
a KOH holding vessel having a mixture inlet and the uranium-bearing KOH solution outlet, wherein the KOH contacting vessel receives the discharged mixed venturi output stream.

13. The system of claim 11 wherein the first separator comprises:
at least one filter, the filter having a filter media sized to retain the particulate CaF₂ with sorbed U compounds on the filter media.

14. The system of claim 13 wherein the at least one filter has a filter media sized to pass particulate CaF₂ but to retain particulate CaF₂ with sorbed U compounds.

15. The system of claim 11 wherein the KOH treatment solution recycler comprises:
a Ca(OH)₂ mixing vessel that mixes Ca(OH)₂ with the received solution containing KF and KOH to convert the KF into KOH and particulate CaF₂, thereby generating a recycled KOH treatment solution stream containing particulate CaF₂,
a second separator that separates at least some particulate CaF₂ from the recycled KOH treatment solution stream; and
a makeup vessel that receives a fresh KOH solution and the recycled KOH treatment solution to generate the KOH treatment solution containing particulate CaF₂.

16. The system of claim 12 wherein the hydrogen fluoride gas containing at least some uranium hexafluoride further includes at least some hydrogen gas and the system further comprises:
the KOH holding vessel having a treated gas outlet in addition to the mixture inlet and the uranium-bearing KOH solution outlet, wherein the KOH contacting vessel receives the discharged mixed venturi output stream which then separates into a vessel gas and the uranium-bearing KOH solution, the vessel gas being discharged from the KOH contacting vessel via the treated gas outlet and the uranium-bearing KOH solution being discharged from the uranium-bearing KOH solution outlet; and
a packed column having a vessel gas inlet, a filtered KOH treatment solution inlet and a treated hydrogen gas outlet, wherein the packed column contacts the vessel gas with filtered KOH treatment solution prior to discharging the treated hydrogen gas.
